(19) United States
(12) Patent Application Publication
(10) Pub. No.: US 2025/0286233 A1
(43) Pub. Date: Sep. 11, 2025

(54) UNIVERSAL ADAPTER FOR BATTERY CONNECTION

(71) Applicant: Vertiv Corporation, Westerville, OH (US)

(72) Inventors: Nayush S. Buradkar, Westerville, OH (US); Sushil Butey, Westerville, OH (US); Kishan Jaysukh-Bhai Jethva, Maharashtra (IN)

(21) Appl. No.: 19/064,281

(22) Filed: Feb. 26, 2025

(30) Foreign Application Priority Data
Mar. 8, 2024 (IN) 202421016919

(51) Int. Cl. H01M 50/503; H01M 50/298; H01M 50/507; H01R 31/06

(52) U.S. Cl. CPC H01M 50/503; H01M 50/298; H01M 50/507; H01R 31/06

(57) ABSTRACT

An adapter for connecting to a plurality of battery terminal configurations of a battery is disclosed. The adapter may include a bracket with a body portion and opposing flanges on opposing edges of the body portion. The bracket may be configured for mounting to a rear portion of the battery. The adapter may include a first connecting busbar and a second connecting busbar, both mounted longitudinally on the body portion and spaced apart. The adapter may include a first sliding busbar and a second sliding busbar, each configured to slidably mount within a slot of the respective connecting busbar. Each sliding busbar may include at least one terminal coupling surface configured to couple to a battery terminal. The adapter may include a pair of first cable connectors and a pair of second cable connectors, each configured to attach to an operative end of the respective connecting busbar.

### CROSS-REFERENCE TO RELATED APPLICATION

The present application claims the benefit of India Provisional Patent Application 202421016919, filed Mar. 8, 2024, titled AN UNIVERSAL ADAPTER FOR BATTERY CONNECTION, which is incorporated herein by reference in the entirety.

### TECHNICAL FIELD

The present disclosure relates to battery connectors, and more specifically, relates to a universal battery connector for connecting the terminals or ports of different types of battery.

### BACKGROUND

The background information herein below relates to the present disclosure but is not necessarily prior art. Typically, lithium-ion batteries manufactured by different manufacturers have distinct configurations with varying connection positions (output terminals or 10 ports), lug sizes, and wire dimensions. Consequently, each lithium-ion battery necessitates a specific adapter to facilitate its electrical connection, which tends to increase the cost of manufacturing of the adapter as well as inventory carrying cost in maintaining the inventory of the adapter.

Moreover, sourcing the precise adapter for a particular type of the lithium-ion battery can pose challenges, leading to compatibility issues and compromising the quality of the connection.

Therefore, there is a need of a universal adapter for the battery connection that can address the aforementioned drawbacks.

### SUMMARY

An adapter for connecting to a plurality of battery terminal configurations of a battery is disclosed in accordance with one or more illustrative embodiments of the present disclosure. In one illustrative embodiment, the adapter may include a bracket with a body portion and opposing flanges on opposing edges of the body portion. In another illustrative embodiment, the bracket may be configured for mounting to a rear portion of the battery. In another illustrative embodiment, the adapter may include a first connecting busbar and a second connecting busbar, both mounted longitudinally on the body portion and spaced apart. In another illustrative embodiment, the adapter may include a first sliding busbar and a second sliding busbar, each configured to slidably mount within a slot of the respective connecting busbar. In another illustrative embodiment, each sliding busbar may include at least one terminal coupling surface configured to couple to a battery terminal. In another illustrative embodiment, the adapter may include a pair of first cable connectors and a pair of second cable connectors, each configured to attach to an operative end of the respective connecting busbar.

In a further aspect, each of the first sliding busbar and the second sliding busbar may include an S-shaped configuration with a segment that protrudes outward from the bracket toward the battery when mounted to the respective connecting busbar. In another aspect, each of the pair of the first cable connectors and the pair of the second cable connectors may include a recess configured to receive the operative end of the respective connecting busbar and at least one hole configured to accommodate an electrical cable. In another aspect, the body portion may define one. In another aspect, the adapter may include an adapter cover removably attachable to a rear side of the bracket for enclosing at least a portion of the first connecting busbar, the second connecting busbar, the first sliding busbar, and the second sliding busbar. In another aspect, the adapter may include fasteners configured to secure the first connecting busbar and the second connecting busbar in place in each respective slot.

In another aspect, the first connecting busbar may represent a positive terminal connection, and the second connecting busbar may represent a negative terminal connection. In another aspect, the adapter may be configured to further mount to a battery mounting rail for connecting multiple batteries in at least one of a parallel configuration or a series configuration. In another aspect, the mounting of the bracket may be configured for mounting to the rear portion of a battery including a rack-compatible battery unit configured to occupy a predetermined number of rack units.

A battery assembly is disclosed in accordance with one or more illustrative embodiments of the present disclosure. In one illustrative embodiment, the battery assembly may include a battery mounting rail. In another illustrative embodiment, the battery assembly may include two or more adapters configured to electrically couple to the battery mounting rail. In another illustrative embodiment, each adapter may be configured to connect to a plurality of battery terminal configurations of a respective battery of a plurality of batteries. In another illustrative embodiment, each adapter may include a bracket with a body portion and flanges on opposing edges of the body portion, the bracket being configured for mounting to a rear portion of the respective battery. In another illustrative embodiment, each adapter may include a first connecting busbar and a second connecting busbar mounted longitudinally on the body portion and spaced apart. In another illustrative embodiment, each adapter may include a first sliding busbar and a second sliding busbar configured to slidably mount within respective slots of the first and second connecting busbars. In another illustrative embodiment, each sliding busbar may include at least one terminal coupling surface configured to couple to a battery terminal. In another illustrative embodiment, each adapter may include a pair of first cable connectors configured to attach to an operative end of the first connecting busbar. In another illustrative embodiment, each adapter may include a pair of second cable connectors configured to attach to an operative end of the second connecting busbar.

In a further aspect, each of the first sliding busbar and the second sliding busbar may include an S-shaped configuration with a segment that protrudes outward from the bracket toward the battery when mounted to the respective connecting busbars. In another aspect, each of the pair of the first cable connectors and the pair of the second cable connectors may include a recess configured to receive the operative ends of the respective connecting busbars and at least one hole configured to accommodate an electrical cable. In another aspect, the body portion may define corresponding holes for receiving the electrical cable of each of the pair of the first cable connectors and the pair of the second cable connectors. In another aspect, each adapter may include an adapter cover removably attachable to a rear side of the bracket for enclosing at least a portion of the connecting and sliding busbars. In another aspect, each adapter may include fasteners configured to secure the connecting busbars in place in each respective slot. In another aspect, the first connecting busbar may represent a positive terminal connection, and the second connecting busbar may represent a negative terminal connection.

In another aspect, the two or more adapters and the battery mounting rail may be configured in a parallel configuration where positive terminals of the plurality of batteries are interconnected at one point and negative terminals are connected at another point. In another aspect, the two or more adapters and the battery mounting rail may be configured in a series configuration where a positive terminal of one battery of the plurality of batteries is linked to a negative terminal of an adjacent battery creating a series connection within the battery mounting rail. In another aspect, each battery of the plurality of batteries may include a rack-compatible battery unit bracket configured to occupy a predetermined number of rack units of a rack, and the bracket may be configured for mounting to the rear portion of the rack-compatible battery unit bracket.

Some of the objects of the present disclosure, which at least one embodiment herein satisfies, are as follows:

It is an object of the present disclosure to ameliorate one or more problems of the prior art or to at least provide a useful alternative.

An object of the present disclosure is to provide a universal adapter for the battery connection of different lithium-ion (Li-ion) batteries.

Another object of the present disclosure is to provide the universal adapter which can accommodate the varied configurations of lithium-ion batteries.

Still another object of the present disclosure is to provide the universal adapter which can be compatible with a wide range of lithium-ion batteries from different suppliers.

Yet another object of the present disclosure is to provide the universal adapter which can minimize the manufacturing costs and reduce the overall inventory carrying cost associated with maintaining multiple adapters.

Still another object of the present disclosure is to provide the universal adapter which can reduce the lead time and enhance the production efficiency.

Yet another object of the present disclosure is to provide the universal adapter which can be protected from electric shock.

Other objects and advantages of the present disclosure will be more apparent from the following description when read in conjunction with the accompanying figures, which are not intended to limit the scope of the present disclosure.

It is to be understood that both the foregoing general description and the following detailed description are exemplary and explanatory only and are not necessarily restrictive of the invention as claimed. Also, it is to be understood that the phraseology and terminology used herein is for the purpose of description and should not be regarded as limiting. The accompanying drawings, which are incorporated in and constitute a part of the specification, illustrate embodiments of the invention, and, together with the general description, serve to explain the principles of the invention.

### BRIEF DESCRIPTION OF THE DRAWINGS

The numerous advantages of the disclosure may be better understood by those skilled in the art by reference to the accompanying figures.

FIG. 1A illustrates a rear isometric view of the adapter, in accordance with one or more embodiments of the present disclosure.

FIG. 1B illustrates a front isometric view of the adapter, in accordance with one or more embodiments of the present disclosure.

FIG. 2 illustrates an exploded view of the adapter, in accordance with one or more embodiments of the present disclosure.

FIGS. 3A-3C illustrate different views of a cable connector, in accordance with one or more embodiments of the present disclosure.

FIG. 4A illustrates a first type of Li-ion battery with a plurality of ports or terminals at an operative rear portion and mounting of different components of the universal adapter, in accordance with an embodiment of the present disclosure.

FIG. 4B illustrates an enlarged view of FIG. 3A with the mounting of different components of the universal adapter at the rear portion of the Li-ion battery, in accordance with one or more embodiments of the present disclosure.

FIG. 5A illustrates a side view of FIG. 4A of the adapter battery assembly, in accordance with one or more embodiments of the present disclosure.

FIG. 5B illustrates an enlarged view of FIG. 5A, in accordance with one or more embodiments of the present disclosure.

FIG. 6A illustrates a second type of Li-ion battery with a plurality of ports or terminals relatively at different position compared to the first type of Li-ion battery and mounting of different components of the universal adapter, in accordance with another embodiment of the present disclosure.

FIG. 6B illustrates an enlarged view of FIG. 5A with the mounting of first connecting busbar to one terminal of the battery, in accordance with one or more embodiments of the present disclosure.

FIG. 6C illustrates an enlarged view of FIG. 5A with the mounting of second connecting busbar to another terminal of the battery, in accordance with one or more embodiments of the present disclosure.

FIG. 7A illustrates a side view of FIG. 6A of the adapter battery assembly, in accordance with one or more embodiments of the present disclosure.

FIG. 7B illustrates an enlarged view of FIG. 7A, in accordance with one or more embodiments of the present disclosure.

FIG. 8A illustrates stacking of plurality of Li-ion battery in a battery mounting rail and connecting each of them in parallel connection by means of a plurality of the adapters, in accordance with one embodiment of the present disclosure.

FIG. 8B illustrates stacking of plurality of Li-ion battery in a battery mounting rail and connecting each of them in series connection by means of a plurality of the adapters, in accordance with another embodiment of the present disclosure.

### LIST OF REFERENCE NUMERALS

1000 battery assembly with adapter
500A battery mounting rail (parallel battery connection)
500B battery mounting rail (series battery connection)
200A first type of Li-ion battery
200B second type of Li-ion Battery
100 Universal adapter for battery connection
20A first connecting busbar
20B second connecting busbar
22A first sliding busbar
22B second sliding busbar
24A first cable connector
24B second cable connector
26 bracket of adapter
28 flange of adapter
30 adapter cover
32 recess to the connecting busbar entry
34 fasteners
36 battery port or terminal

### DETAILED DESCRIPTION

Reference will now be made in detail to the subject matter disclosed, which is illustrated in the accompanying drawings.

The present disclosure relates to battery connectors, and more specifically, relates to a universal battery connector for connecting the terminals or ports of different types of battery.

Embodiments are provided so as to thoroughly and fully convey the scope of the present disclosure to a person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, elements, modules, units, and/or components, but do not forbid the presence or addition of one or more other features, elements, components, and/or groups thereof.

Typically, the lithium-ion batteries (e.g., rack unit batteries for power distribution racks or the like) produced by different manufacturers feature distinct configurations for their output terminals or ports. These batteries often come with varying connection positions, lug sizes, and wire dimensions. Consequently, each lithium-ion battery necessitates a specific adapter to facilitate its electrical connection, which tends to increase the cost of manufacturing of the adapter as well as inventory carrying cost in maintaining the inventory of the adapter. Moreover, sourcing the precise adapter for a particular type of the lithium-ion battery can pose challenges, leading to compatibility issues and compromising the quality of the connection. This difficulty in finding suitable adapters can disrupt the production process.

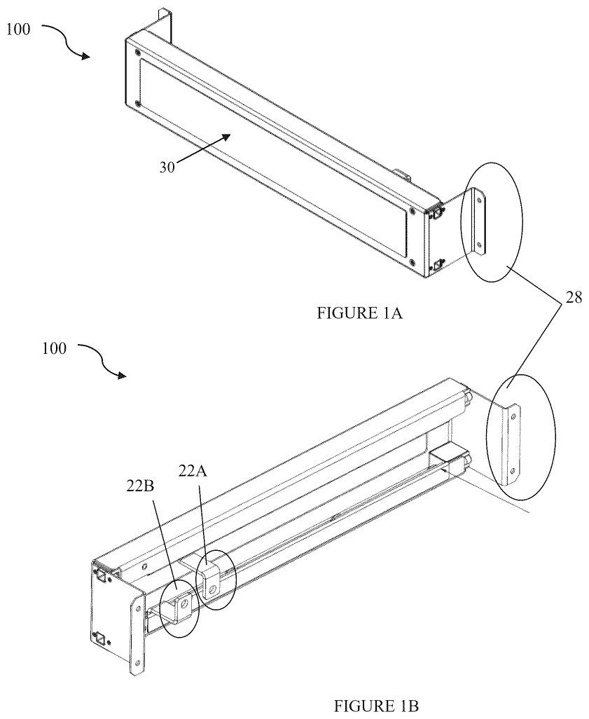

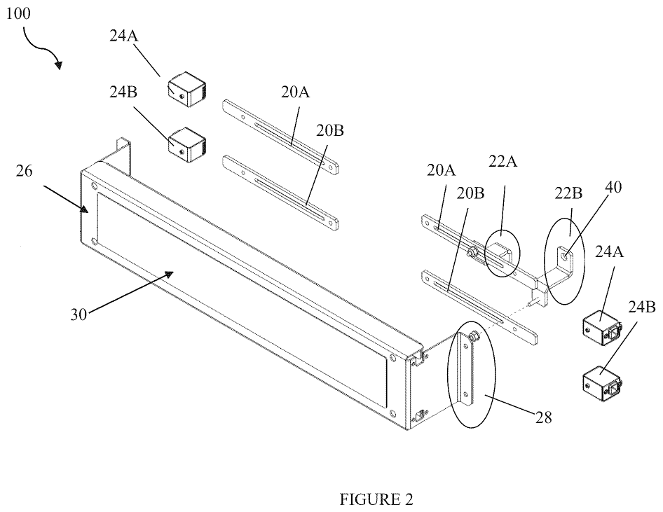

FIG. 1A illustrates a rear isometric view of the adapter, while FIG. 1B illustrates a front isometric view of the adapter, in accordance with one or more embodiments of the present disclosure. FIG. 2 illustrates an exploded view of the adapter, in accordance with one or more embodiments of the present disclosure.

The universal adapter (hereinafter referred as adapter 100) is defined by a U-shaped bracket 26 body, extending along the length of the battery and a flange 28 portion, extending perpendicular to the body portion. The adapter 100 body may be configured with an adapter cover 30, configured to be removably attachable (e.g. snap onto with tabs and corresponding recesses) to the body of the adapter 100 from the rear side, as depicted in FIG. 1A. The adapter cover 30 may be configured to enclose at least a portion of the first connecting busbar 20A, the second connecting busbar 20B, the first sliding busbar 22A, and the second sliding busbar 22B. For instance, the adapter cover 30 may be configured to shield, using an outer surface, a user from reaching into the bracket 26, and being electrically shocked. The two flanges 28 may be configured to mount the adapter 100 to an operative rear portion of the battery.

In accordance with one or more embodiments of the present disclosure, the adapter 100 may comprise a bracket 26 with a pair of flanges 28 on opposing edges, a first connecting busbar 20A, a second connecting busbar 20B, a first sliding busbar 22A, a second sliding busbar 22B, a pair of first cable connectors 24A, and a pair of second cable connectors 24B. The first connecting busbar 20A and the second connecting busbar 20B may be longitudinally mounted on an operative portion of the bracket 26, extending along the length of the battery. These connecting busbars may be spaced apart to prevent the possibility of electrical short-circuiting and are equipped with a slot. The first sliding busbar 22A and the second sliding busbar 22B may be configured to be slidably mounted within the slot of the respective first connecting busbar 20A and the second connecting busbar 20B. Each sliding busbar 22A, 22B includes at least one terminal coupling surface 40 (e.g., hole), which is configured to electrically couple to (e.g., receive or mate to) an operative terminal or port 36 of the Li-ion battery. The bracket 26 may be configured for mounting to the rear portion of a battery, such as a rack-compatible battery unit configured to occupy a predetermined number of rack units of a rack. For example, the battery may be configured to provide redundant power distribution. For instance, the battery may include a rectangular rear portion and the bracket 26 may be a rectangular shape.

In an embodiment, each of the sliding busbar(s) is defined by a S-shaped configuration. Consequently, when these sliding busbars are affixed onto their corresponding connecting busbars 20A, 20B, a segment of the sliding busbars 22A, 22B extends or protrudes outward from the bracket 26 of the adapter 100 to make contact with the battery terminal 36 effectively.

In an embodiment, the first sliding busbar 22A and the second sliding busbar 22B can slide over the respective connecting busbar 20A, 20B, aligning themselves with the positioning of the battery ports or terminals. Each sliding busbar 22A, 22B can be firmly attached to its corresponding battery port 36 by means of fasteners 34.

In an embodiment, the sliding motion of the first and second sliding busbars 22A, 22B can be secured in place on their respective connecting busbars 20A, 20B by tightening the fasteners 34.

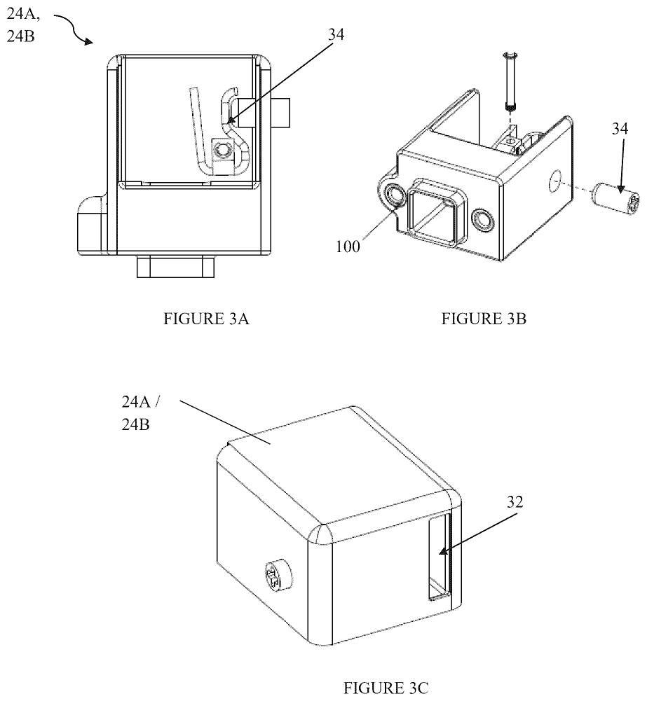

Further, each of the first cable connectors 24A, and the second cable connectors 24B may be configured with a recess 32 (e.g., slot) and at least one hole therein. In an embodiment, the first cable connectors 24A may be securely attached to, and electrically coupled to, the operative end of the first connecting busbar 20A, utilizing the recess 32 to accommodate (e.g., receive by insertion) the end portion of the first connecting busbar 20A. FIG. 3A-3C illustrates different views of the cable connectors 24A, 24B in accordance with one or more embodiments of the present disclosure.

Similarly, in another embodiment, the second cable connectors 24B can be fastened and electrically coupled to the operative end of the second connecting busbar 20B, with their recess 32 configured to receive the corresponding end portion of the second connecting busbar 20B.

Additionally, the holes present on the first and second cable connectors 24A, 24B are configured to accommodate cables for electrical connections. These cables can be firmly held in place within their respective connectors by tightening the respective fasteners 34, provided therein.

In an embodiment, the first connecting busbar 20A, the second connecting busbar 20B, the first sliding busbar 22A, the second sliding busbar 22B, the pair of first cable connectors 24A, and the pair of second cable connector 24B are made of electrically conducting material (e.g., metal). In an embodiment, the first connecting busbar 20A represents (e.g., is configured to couple to) the positive terminal for the battery and the second connecting busbar 20B represents the positive terminal for the battery or vice-versa.

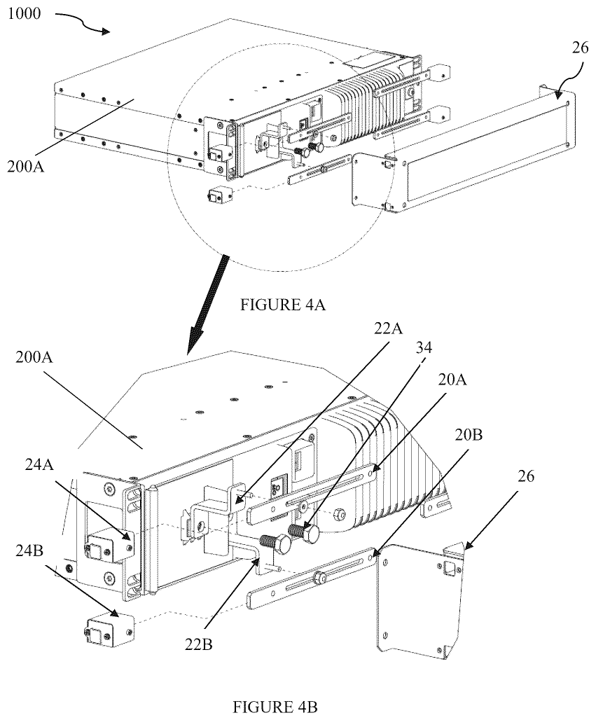

In a first embodiment, a battery assembly 1000 with the adapter is shown which includes: a first type of Li-ion battery 200A is connected by the universal adapter 100. FIG. 4A illustrates the mounting of different components of the adapter 100 to the rear portion of the first type of Li-ion battery.

At least one of the first sliding busbar 22A and the second sliding busbar 22B are securely attached to the corresponding ports or terminals 36 of the battery by means of the fasteners 34. Similarly, the operative ends of the respective cable connectors 24A, 24B are affixed to the corresponding connecting busbars 20A, 20B using fasteners 34. Both the first and second cable connectors 24A, 24B are positioned at the end portions of their respective connecting busbars 20A, 20B.

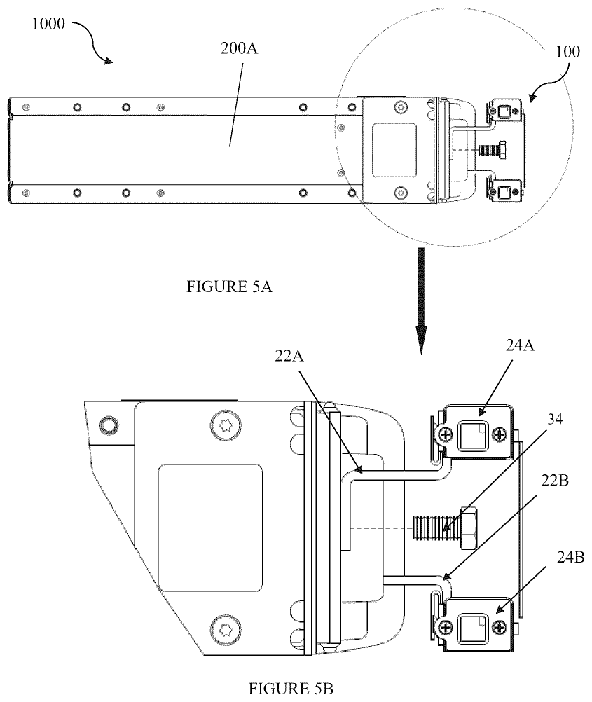

FIG. 4B illustrates an enlarged view of FIG. 3A with the mounting of different components of the adapter 100 at the rear portion of the Li-ion battery 200A. Additionally, FIG. 5A illustrates a side view of the FIG. 4A of the adapter 100 battery assembly 1000, while FIG. 5B illustrates an enlarged view of FIG. 5A.

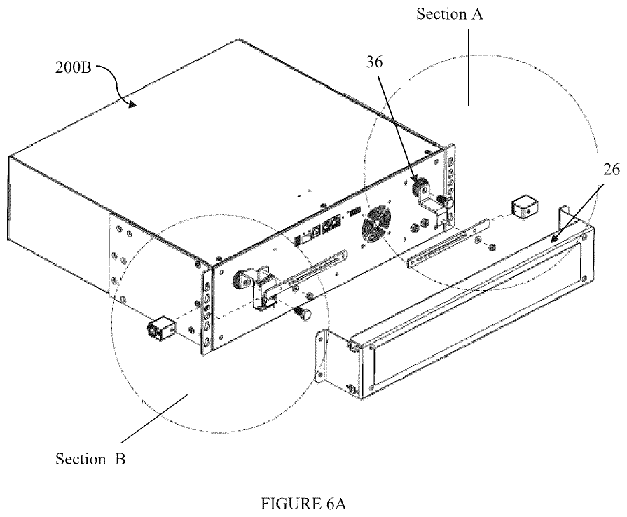

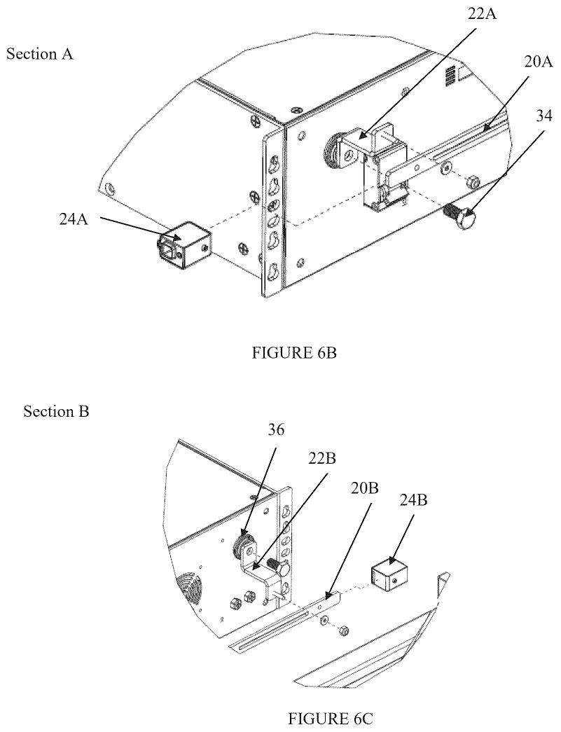

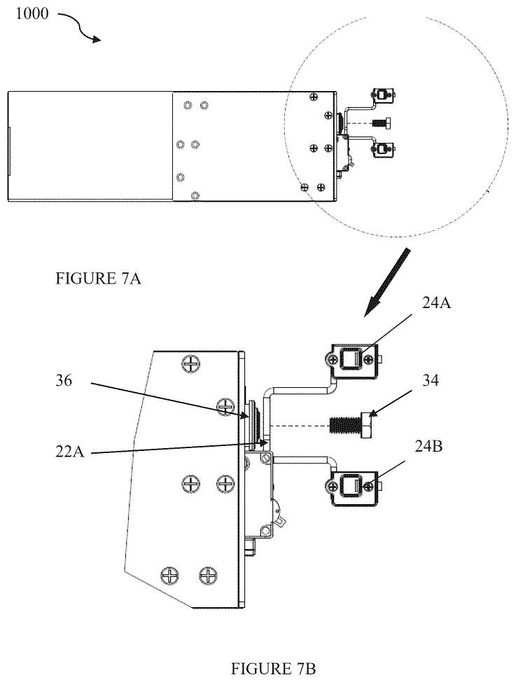

In a second embodiment, another battery assembly 1000 with the adapter 100 is shown which includes: a second type of Li-ion battery 200B connected by the universal adapter 100. The FIG. 6A illustrates a second type of Li-ion battery 200B with a plurality of ports or terminals 36 relatively at different position compared to the first type of Li-ion battery 200A and mounting of different components of the adapter 100. FIG. 6B illustrates an enlarged view of FIG. 5A with the mounting of the first connecting busbar 20A to one terminal of the battery, in accordance with one or more embodiments of the present disclosure. FIG. 6C illustrates an enlarged view of FIG. 5A with the mounting of second connecting busbar 20B to another terminal of the battery. FIG. 7A illustrates a side view of FIG. 6A of the adapter battery assembly 1000, while FIG. 7B illustrates an enlarged view of FIG. 7A.

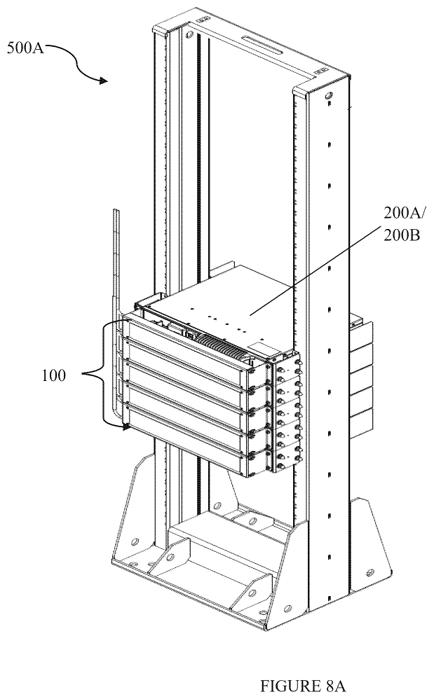

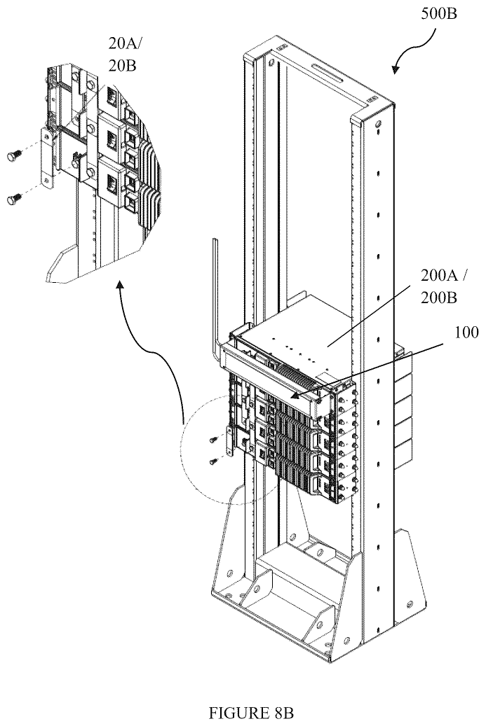

In a third embodiment, an array of Li-ion batteries 200A, 200B, including either the first type, the second type, or a combination thereof, is arranged on a vertical rail. Each battery is equipped with its own adapter 100 at the rear portion. The positive terminals of the batteries are interconnected at one point, while the negative terminals are connected at another point to establish parallel battery connection within the battery mounting rail 500A. FIG. 8A illustrates stacking of a plurality of Li-ion batteries to a battery mounting rail 500A and connecting each of the plurality of Li-ion batteries in parallel connection by a plurality of the adapters 100, in accordance with one or more embodiments of the present disclosure.

In a fourth embodiment, a similar array of Li-ion batteries 200A, 200B is shown, however, in this configuration, the positive terminal of one battery is linked to the negative terminal of the adjacent battery and so forth, creating a series battery connection with the battery mounting rail. FIG. 8B illustrates stacking a plurality of Li-ion batteries with a battery mounting rail and connecting each of them in series connection by means of a plurality of the adapter 100, in accordance with another embodiment of the present disclosure.

The foregoing description of the embodiments has been provided for purposes of illustration and not intended to limit the scope of the present disclosure. Individual components of a particular embodiment are generally not limited to that particular embodiment but are interchangeable. Such variations are not to be regarded as a departure from the present disclosure, and all such modifications are considered to be within the scope of the present disclosure.

The present disclosure described herein above has several technical advantages including, but not limited to the universal adapter for the battery connection, that: can provide modular configuration for lithium-ion battery connections, to promote uniformity across manufacturers; can reduce the need of multiple adapters for different lithium-ion battery connections; can mitigate the risk of connection issues and production delays; can minimize the manufacturing costs and reduce the overall inventory carrying cost associated with maintaining multiple adapters; and can reduce lead times and enhance the production efficiency.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprises”, or variations such as “comprises” or “comprising”, will be understood to imply the inclusion of a stated element, or group of elements, but not the exclusion of any other element, or group of elements.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

We claim:

1. An adapter for connecting to a plurality of battery terminal configurations of a battery comprising:
a bracket comprising a body portion and flanges on opposing edges of the body portion, the bracket being configured for mounting to a rear portion of the battery;
a first connecting busbar mounted longitudinally on the body portion;
a second connecting busbar mounted longitudinally on the body portion and spaced apart from the first connecting busbar;
a first sliding busbar configured to slidably mount within a slot of the first connecting busbar;
a second sliding busbar configured to slidably mount within a slot of the second connecting busbar; and wherein each sliding busbar includes at least one terminal coupling surface configured to couple to a battery terminal;
a pair of first cable connectors, each of the pair of the first cable connectors configured to attach to an operative end of the first connecting busbar; and
a pair of second cable connectors, each of the pair of the second cable connectors configured to attach to an operative end of the second connecting busbar.

2. The adapter of claim 1, wherein each of the first sliding busbar and the second sliding busbar comprise an S-shaped configuration with a segment that protrudes outward from the bracket toward the battery when mounted to, respectively, the first connecting busbar and the second connecting busbar.

3. The adapter of claim 1, wherein each of the pair of the first cable connectors and the pair of the second cable connectors comprise: a recess configured to receive, respectively, the operative end of the first connecting busbar and the operative end of the second connecting busbar; and at least one hole configured to accommodate an electrical cable.

4. The adapter of claim 3, wherein the body portion defines corresponding holes for receiving the electrical cable of each of the pair of the first cable connectors and the pair of the second cable connectors.

5. The adapter of claim 1, further comprising:
an adapter cover removably attachable to a rear side of the bracket for enclosing at least a portion of the first connecting busbar, the second connecting busbar, the first sliding busbar, and the second sliding busbar.

6. The adapter of claim 1, further comprising fasteners configured to secure the first connecting busbar and the second connecting busbar in place in each respective slot.

7. The adapter of claim 1, wherein: the first connecting busbar represents a positive terminal connection; and the second connecting busbar represents a negative terminal connection.

8. The adapter of claim 1, wherein the adapter is further mounted to a battery mounting rail connecting multiple adapters, each adapter configured to couple with a corresponding battery, wherein the battery mounting rail and the multiple adapters are in a parallel configuration.

9. The adapter of claim 1, wherein the adapter is further mounted to a battery mounting rail connecting multiple adapters, each adapter configured to couple with a corresponding battery, wherein the battery mounting rail and the multiple adapters are in a series configuration.

10. The adapter of claim 1, wherein the battery comprises a rack-compatible battery unit bracket configured to occupy a predetermined number of rack units of a rack, and wherein the bracket is configured for mounting to the rear portion of the rack-compatible battery unit bracket.

11. A battery assembly comprising:
a battery mounting rail; and
two or more adapters configured to electrically couple to the battery mounting rail, each adapter configured to connect to a plurality of battery terminal configurations of a respective battery of a plurality of batteries, each adapter comprising:
a bracket comprising a body portion and flanges on opposing edges of the body portion, the bracket being configured for mounting to a rear portion of the respective battery;
a first connecting busbar mounted longitudinally on the body portion;
a second connecting busbar mounted longitudinally on the body portion and spaced apart from the first connecting busbar;
a first sliding busbar configured to slidably mount within a slot of the first connecting busbar;
a second sliding busbar configured to slidably mount within a slot of the second connecting busbar; and wherein each sliding busbar includes at least one terminal coupling surface configured to couple to a battery terminal;
a pair of first cable connectors, each of the pair of the first cable connectors configured to attach to an operative end of the first connecting busbar; and
a pair of second cable connectors, each of the pair of the second cable connectors configured to attach to an operative end of the second connecting busbar.

12. The battery assembly of claim 11, wherein each of the first sliding busbar and the second sliding busbar comprise an S-shaped configuration with a segment that protrudes outward from the bracket toward the battery when mounted to, respectively, the first connecting busbar and the second connecting busbar.

13. The battery assembly of claim 11, wherein each of the pair of the first cable connectors and the pair of the second cable connectors comprise: a recess configured to receive, respectively, the operative end of the first connecting busbar and the operative end of the second connecting busbar; and at least one hole configured to accommodate an electrical cable.

14. The battery assembly of claim 13, wherein the body portion defines corresponding holes for receiving the electrical cable of each of the pair of the first cable connectors and the pair of the second cable connectors.

15. The battery assembly of claim 11, wherein each adapter further comprises:
an adapter cover removably attachable to a rear side of the bracket for enclosing at least a portion of the first connecting busbar, the second connecting busbar, the first sliding busbar, and the second sliding busbar.

16. The battery assembly of claim 11, wherein each adapter further comprises fasteners configured to secure the first connecting busbar and the second connecting busbar in place in each respective slot.

17. The battery assembly of claim 11, wherein: the first connecting busbar represents a positive terminal connection; and the second connecting busbar represents a negative terminal connection.

18. The battery assembly of claim 11, wherein the two or more adapters and the battery mounting rail are configured in a parallel configuration wherein positive terminals of the plurality of batteries are interconnected at one point and negative terminals are connected at another point.

19. The battery assembly of claim 11, wherein the two or more adapters and the battery mounting rail are configured in a series configuration wherein a positive terminal of one battery of the plurality of batteries is linked to a negative terminal of an adjacent battery creating a series connection within the battery mounting rail.

20. The battery assembly of claim 11, wherein each battery of the plurality of batteries comprises a rack-compatible battery unit bracket configured to occupy a predetermined number of rack units of a rack, and wherein the bracket is configured for mounting to the rear portion of the rack-compatible battery unit bracket.
